(19) United States
(12) Patent Application Publication
(10) Pub. No.: US 2008/0190270 A1
(43) Pub. Date: Aug. 14, 2008

(54) SYSTEM AND METHOD FOR ONLINE COMPOSITION, AND COMPUTER-READABLE RECORDING MEDIUM THEREFOR

(76) Inventor: Taegoo Kang, Seoul (KR)

Correspondence Address: CHRISTIE, PARKER & HALE, LLP, PO BOX 7068, PASADENA, CA, 91109-7068, US

(21) Appl. No.: 11/877,594

(22) Filed: Oct. 23, 2007

(30) Foreign Application Priority Data
Feb. 13, 2007 (KR) 10-2007-0014992
Apr. 16, 2007 (KR) 10-2007-0036922

(51) Int. Cl. G10H 7/00

(52) U.S. Cl. 84/613; 84/609

(57) ABSTRACT

The present invention relates to a system, a method, and a computer-readable recording medium, which enable ordinary persons other than professional composers to easily compose music by using a music database provided by an online server. According to one aspect of the present invention, a composition system is provided, which comprises at least one database including a plurality of blocked musical elements and a composition server. The composition server includes a receiving portion for receiving a signal associated with a melody shape inputted from a terminal, a sound standardizing portion for analyzing tones and beats of a sound depicted by the melody shape and standardizing the sound, and a storage device for storing the sound standardized by the sound standardizing portion, wherein the standardized sound is capable of being transmitted, as at least one blocked musical element, to the terminal.

### CROSS-REFERENCE TO RELATED APPLICATION

This application claims priority to and the benefit of Korean Patent Application No. 10-2007-0014992 filed in the Korean Intellectual Property Office on Feb. 13, 2007 and Korean Patent Application No. 10-2007-0036922 filed in the Korean Intellectual Property Office on Apr. 16, 2007, the entire content of each of which is incorporated herein by reference.

### FIELD OF THE INVENTION

The present invention relates to a system, a method, and a computer-readable recording medium, which enable ordinary persons other than professional composers to easily compose music by using a music database provided by an online server.

### BACKGROUND OF THE INVENTION

In a conventional, well-known composition method, a composer produces music by writing notes on a music sheet while playing a musical instrument that the composer can play for himself or herself. Even when the composer desires to modify the music after the composition, he or she has to repeatedly play an instrument and change the tones and the beats expressed by the notes in the original music sheet. Therefore, according to the conventional composition method, a composer has been required to have high-level musical knowledge and talents and exert a long time and efforts to complete music composition, due to the complicated composition process, explained as above. Specifically, a process of composing an ensemble involving a plurality of instruments is more difficult.

Since a while ago, computer music has been introduced to resolve the aforementioned difficulties in composition. Herein, “computer music” means music generated or composed with the aid of a computer. Computer music may be a product from all kinds of musical activities, such as composition, sound adjustment, music synthesis, performance, and so on. More specifically, such computer music may be generated with the aid of a composition program on a computer or an audio equipment capable of outputting sounds of various instruments. Even in case of producing computer music, a composer is required to perform complicated operations on a computer. Accordingly, a composer's composition style and spirit tend to be reflected in the computer music.

As an example of computer music, “Illiac Suite for String Quartet” that was experimentally composed by L. A. Hiller and L. M. Isaacson of the University of Illinois in 1957 may be mentioned. Thereafter, other composers have been composing music by using a computer.

However, even when a composer composes music by using a computer, the composer has to draw any kind of music sheet by inputting tones and beats through a composition program to translate sounds from an instrument into MIDI signals. In the computer-based composition, other instruments may be selected and sounds from the selected instrument can be easily expressed in the music sheet while or after the music sheet is being created. Further, the composer may readily listen to the composed music by playing the music expressed in the music sheet.

Meanwhile, computer-based composition may be enabled without playing an instrument, depending on a used composition program. As an exemplary composition method, which would be especially useful for a user lacking composition skills or having no instrument, a method of clicking on a piano keyboard on a computer screen with a computer input device (e.g., a mouse or a computer keyboard) and drawing a music sheet may be suggested. However, since this conventional composition method also requires a user to input every tone and beat of a sound by using a computer input device, following this method would be very inefficient. Moreover, it is very difficult for ordinary persons other than professional composers to complete matching chords by selecting and inputting musical notes in the music sheet.

As described above, the computer-based composition technology has been continuously developed, and provides users with much convenience. However, it is still clear that even in case of the computer-based composition, basic musical knowledge regarding how to play an instrument and how to draw a music sheet is required. Moreover, conventional composition programs are very expensive and a user's computer with such a composition program has been required to have a memory capacity of 10 Gbytes or more to store sound sources for representing a variety of instrument sounds. Accordingly, with the conventional composition programs, ordinary persons feel difficulty in composing music.

### SUMMARY OF THE INVENTION

It is, therefore, one object of the present invention to solve the problems as above.

It is another object of the present invention to enable ordinary persons having no specialty in composition to easily compose music.

It is yet another object of the present invention to spare the storage of a user computer by instead using the storage of a server computer.

The configurations of the present invention for accomplishing the above objects of the present invention are as follows.

In one aspect of the present invention, a composition system is provided, which comprises at least one database including a plurality of blocked musical elements, and a composition server, which includes a receiving portion for receiving a signal associated with a melody shape inputted from a terminal, a sound standardizing portion for analyzing tones and beats of a sound depicted by the melody shape and standardizing the sound, and a storage device for storing the sound standardized by the sound standardizing portion, wherein the standardized sound is capable of being transmitted, as at least one blocked musical element, to the terminal.

In another aspect of the present invention, a composition system is provided, which comprises at least one database including a plurality of blocked musical elements, and a composition server, which includes a receiving portion for receiving chord information of music that is being composed in a terminal, and a musical element recommendation portion for recommending at least one blocked musical element from the at least one database based on the received chord information, wherein the at least one recommended blocked musical element is capable of being transmitted to the terminal.

In yet another aspect of the present invention, a composition system is provided, which comprises at least one database including a plurality of blocked musical elements, and a composition server, which includes a receiving portion for receiving key information of music that is being composed in a terminal, and a musical element extraction portion for extracting at least one blocked musical element from the at least one database based on the key information, wherein the at least one extracted blocked musical element is capable of being transmitted to the terminal.

In still yet another aspect of the present invention, a composition system is provided, which comprises at least one database including a plurality of blocked musical elements, and a composition server, which includes a first receiving portion for receiving a signal associated with a melody shape inputted from a terminal, a second receiving portion for receiving chord information of music that is being composed in the terminal, a sound standardizing portion for analyzing tones and beats of a sound depicted by the melody shape and standardizing the sound, a chord adjusting portion for adjusting the standardized sound based on the received chord information, a storage device for storing the standardized and chord-adjusted sound, and a virtual instrument for playing the standardized and chord-adjusted sound, wherein the standardized and chord-adjusted sound is capable of being transmitted, as at least one blocked musical element, to the terminal.

In still yet another aspect of the present invention, a method for implementation in a composition system is provided, which comprises at least one database including a plurality of blocked musical elements and a composition server. The method comprises the steps of receiving a signal associated with a melody shape inputted from a terminal, analyzing tones and beats of a sound depicted by the melody shape and standardizing the sound, and storing the standardized sound, wherein the standardized sound is capable of being transmitted, as at least one blocked musical element, to the terminal.

In still yet another aspect of the present invention, a method for implementation in a composition system is provided, which comprises at least one database including a plurality of blocked musical elements and a composition server. The method comprises the steps of receiving chord information of music that is being composed in a terminal, and recommending at least one blocked musical element from the at least one database based on the received chord information, wherein the at least one recommended blocked musical element is capable of being transmitted to the terminal.

In still yet another aspect of the present invention, a method for implementation in a composition system is provided, which comprises at least one database including a plurality of blocked musical elements and a composition server. The method comprises the steps of receiving key information of music that is being composed in a terminal, and extracting at least one blocked musical element from the at least one database based on the key information, wherein the at least one extracted blocked musical element is capable of being transmitted to the terminal.

In still yet another aspect of the present invention, a method for implementation in a composition system is provided, which comprises at least one database including a plurality of blocked musical elements and a composition server. The method comprises the steps of receiving a signal associated with a melody shape inputted from a terminal and chord information of music that is being composed in the terminal, analyzing tones and beats of a sound depicted by the melody shape and standardizing the sound, adjusting the standardized sound based on the received chord information, and playing the standardized and chord-adjusted sound with a virtual instrument, wherein the standardized and chord-adjusted sound is capable of being transmitted, as at least one blocked musical element, to the terminal.

In still yet another aspect of the present invention, a method for implementation in a terminal is provided, which comprises at least one database including a plurality of blocked musical elements. The method comprises the steps of receiving and storing a signal associated with a user's voice, analyzing tones and beats of the voice and standardizing the voice, and storing the standardized voice, wherein the standardized voice is provided as at least one blocked musical element.

In still yet another aspect of the present invention, a method for implementation in a terminal is provided, which comprises at least one database including a plurality of blocked musical elements. The method comprises the steps of receiving and storing a signal associated with a melody shape inputted from the terminal, analyzing tones and beats of a sound depicted by the melody shape and standardizing the sound, and storing the standardized sound, wherein the standardized sound is provided as at least one blocked musical element.

In still yet another aspect of the present invention, a method for implementation in a terminal is provided, which comprises at least one database including a plurality of blocked musical elements. The method comprises the steps of obtaining chord information of music that is being composed in the terminal, and recommending at least one out of the plurality of blocked musical elements based on the obtained chord information.

In still yet another aspect of the present invention, a method for implementation in a terminal is provided, which comprises at least one database including a plurality of blocked musical elements. The method comprises the steps of obtaining key information of music that is being composed in the terminal, and extracting from the at least one database at least one out of the plurality of blocked musical elements based on the obtained key information.

In still yet another aspect of the present invention, a method for implementation in a terminal is provided, which comprises at least one database including a plurality of blocked musical elements. The method comprises the steps of receiving a signal associated with a user's voice and chord information of music that is being composed in the terminal, analyzing tones and beats of the voice and standardizing the voice, adjusting the standardized voice based on the received chord information, and storing the standardized and chord-adjusted voice, wherein the standardized and chord-adjusted voice is provided as at least one blocked musical element.

In still yet another aspect of the present invention, a method for implementation in a terminal is provided, which comprises at least one database including a plurality of blocked musical elements. The method comprises the steps of receiving a signal associated with a user's voice and chord information of music that is being composed in the terminal, analyzing tones and beats of the voice and standardizing the voice, adjusting the standardized voice based on the received chord information, and playing the standardized and chord-adjusted voice with a virtual instrument, wherein the sound from the virtual instrument is provided as at least one blocked musical element.

In still yet another aspect of the present invention, a method for implementation in a terminal is provided, which comprises at least one database including a plurality of blocked musical elements. The method comprises the steps of receiving a signal associated with a melody shape inputted from the terminal and chord information of music that is being composed in the terminal, analyzing tones and beats of a sound depicted by the melody shape and standardizing the sound, adjusting the standardized sound based on the received chord information, and playing the standardized and chord-adjusted sound with a virtual instrument, wherein the sound from the virtual instrument is provided as at least one blocked musical element.

In still yet another aspect of the present invention, provided is a computer recording medium for recording a computer program for implementing the method in accordance with any of the above.

### BRIEF DESCRIPTION OF THE DRAWINGS

The above objects and features of the present invention will become more apparent from the following description of the preferred embodiments given in conjunction with the accompanying drawings, in which:

FIG. 1 is a schematic diagram of a composition system in accordance with the present invention;

FIG. 2 illustrates an example of a user interface of a composition system in accordance with the present invention;

FIG. 3 is a flowchart illustrating the usage of a voice recording function provided by a composition system in accordance with an embodiment of the present invention;

FIG. 4 is a flowchart illustrating the usage of a voice recording function provided by a composition system in accordance with another embodiment of the present invention;

FIG. 5 is a flowchart illustrating the usage of a key adjustment function provided by a composition system in accordance with an embodiment of the present invention; and

FIG. 6 illustrates an example of another user interface of a composition system in accordance with the present invention.

### DETAILED DESCRIPTIONS OF THE PREFERRED EMBODIMENTS

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from to the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

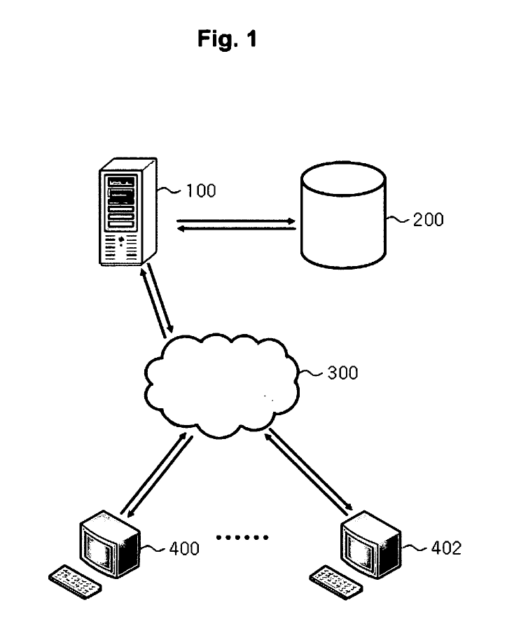

FIG. 1 is a schematic diagram of a composition system in accordance with the present invention.

Referring to FIG. 1, the composition system in accordance with the present invention includes a server 100, a database 200, the Internet 300, and user computers 400 and 402. In a preferred embodiment of the present invention, the server 100 communicates with the database 200 and the user computers 400 and 402 via the Internet 300. The server 100 transmits data extracted from the database 200 to the user computers 400 and 402, and receives data from the user computers 400 and 402. The Internet 300 is a well-known computer network, and the user computers 400 and 402 are terminals. Although the database 200 is described as being separated from and communicating with the server 100 in this embodiment, the database 200 may be included in the server 100 in accordance with another embodiment of the present invention. Although only two user computers 400 and 402 are described in FIG. 1, the number of user computers connected with the server 100 should not be particularly limited.

A preferred embodiment of the present invention will be described in a more detailed manner with reference to FIG. 1.

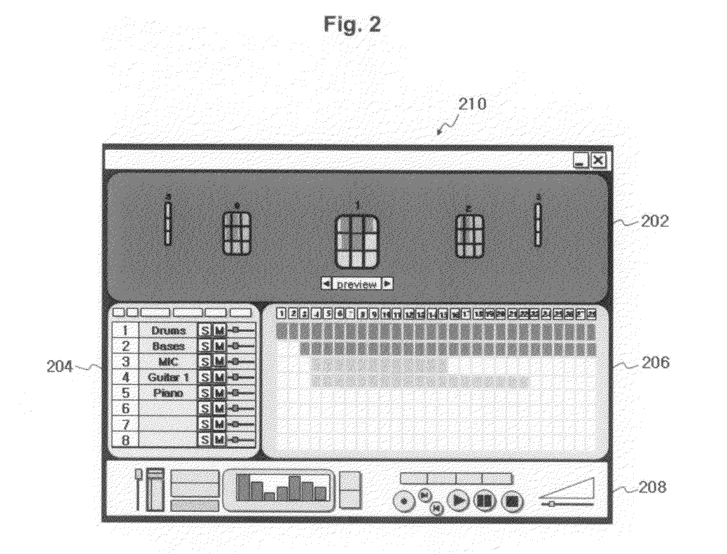

The server 100 includes a program module (not shown) for extracting and transmitting music files. The server 100 may further include a storage device (not shown) for storing a user's voice received from the user computer 400 or 402 or a shape of a user input melody. The server 100 may further include a program module (not shown) for creating a standardized music score based on the user's voice received from the user computer 400 or 402 or the melody shape inputted by the user. The server 100 may further include a program module (not shown) for classifying music files depending on the genre or the singer's music style. The server 100 may further include a composition software package (not shown) downloaded to and installed on the user computer 400 or 402. This composition software package is installed on the user computer 400 or 402 to provide a user interface, with which a user can receive a music file from the server 100 and more easily compose music. The user interface will be described below, with reference to FIG. 2.

Preferably, music files may be stored in the database 200. Music files may be classified depending on the genre or the singer's music style (by a well-known music analysis scheme), and then stored in the database 200. Examples of the well-known music analysis scheme are found in “A Study on the Robust Content-Based Musical Genre Classification System Using Multi-Feature Clustering,” by Won-Joong Yoon, Kyu-Sik Park, and Kang-Kyu Lee (Institute of Electronics Engineers of Korea (IEEK), Vol. 42, SP, No. 3, May 2005), Korean Patent Application No. 10-2005-0024676 entitled “Musical Genre Classification Method Using k-NN Classification Algorithm” by Jae-Chon Kim, filed on Mar. 24, 2005, and Korean Patent Application No. 10-2005-0033260 entitled “Instrument Signal Recognition And Genre Classification Method Using Bayesian Method” by Jae-Chon Kim and Gyeong-Seop Gwak, filed on Apr. 21, 2005, the entire content of each of which is incorporated by reference herein. Also, other known techniques may be used for realizing the present invention, if needed.

The server 100 extracts music files from the database 200 and transmits the music files to the user computer 400 or 402. More preferably, the music files stored in the database 200 are musical elements that are blocked in units of word or measure, or other small units (i.e., music files that can be replayed in a small unit). A technique utilizing such blocked musical elements is disclosed by Silent Music Band, Co. Ltd. in Korean Patent Application No. 10-2005-0036825, filed on May 2, 2005 and published on Nov. 8, 2006, the entire content of which is incorporated by reference herein. This patent application discloses a music database that stores a variety of music files that are classified, for example, depending on the genre, so that a user can extract a desired music file from the database and compose music.

The user computer 400 or 402 may include a composition software package downloaded from the server 100, as described above. This downloaded composition software package is capable of downloading at least part (e.g., blocked musical elements extracted depending on a genre or a singer's music style) of the database 200 from the server 100 and storing that part in the user computer 400 or 402. After the download, the composition software package in accordance with the present invention can directly perform an entirety or part of the processes that, otherwise, should be performed by the server 100, utilizing the downloaded part of the database 200. Surely, the composition software package may provide a user interface for enabling a user to compose music.

Anyone of the server 100 or the computer 400 or 402 has a recording medium (not shown) including a hard disc, a floppy disc, a magnetic tape, a CD-ROM, a DVD, a floptical disc, a ROM, a RAM and a flash memory, which stores the computer program for enabling the computer system of FIG. 1 to implement each of the methods and/or processes discussed herein.

An operation of the composition system in accordance with an embodiment of the present invention will now be described with reference to FIG. 2. FIG. 2 illustrates an example of a user interface of a composition system in accordance with the present invention.

First, a user downloads a composition software package from a server 100 to a user computer 400 or 402. The user then executes the composition software package and selects a genre of blocked musical elements that he or she wants to use. The selectable musical genre may be, for example, rock & roll, rhythm & blues, hip-hop, jazz, trot, dance, rap, ballads, folk, classic, and the like. Alternatively, when the user selects a singer's music style, blocked musical elements belonging to the selected music style may be provided.

According to an embodiment of the present invention, the blocked musical elements may be further classified depending on the genre or the singer's music style. Such classification may be enabled by a well-known logic of ‘Music Genome Project’ proposed by Tim Westergren in January, 2000, which is being used for comparing some features of a musical element with those of another musical element (The entire content of the above logic is incorporated by reference in this specification). According to this logic, the number of usable features reaches up to 400.

After the user selects a genre or a singer's music style, a user interface 210 as shown in FIG. 2 may be actuated. The user interface 210 includes a music block group display portion 202, a track setting portion 204, a music block arranging portion 206, and a control portion 208.

The user can select a desired instrument on the track setting portion 204, which is located at the left of the user interface 210. As shown in FIG. 2, a drum may be first selected for track 1 on the track setting portion 204. When the drum is selected as such, music block groups are displayed on the music block group display portion 202. Then, music block groups having blocked musical elements containing drum sounds may be represented. Herein, the blocked musical elements in the music block groups may be arranged on the music block arranging portion 206 by a drag-and-drop action. Surely, all of the blocked musical elements displayed on the music block group display portion 202 belong to the selected genre or singer's music style. For the convenience of users, in each music block group displayed on the music block group display portion 202, which belongs to the genre or singer's music style, blocked musical elements are further grouped by other features.

Preferably, when the user selects any of the music block groups on the music block group display portion 202 and requests for a preview, a blocked musical element in the music block group may be replayed. Thus, the user can listen to the blocked musical element in advance before arranging the blocked musical element on the music block arranging portion 206.

When the user selects one of the blocked musical elements displayed on the music block group display portion 202 and then arranges it on the music block arranging portion 206 by using a mouse or other input device of the user computer 400 or 402 (preferably, by a drag-and-drop action), a small music file corresponding to the selected blocked musical element is extracted from the database 200 and transmitted to the user computer 400 or 402 by the server 100. According to another embodiment of the present invention, blocked musical elements belonging to the genre or singer's music style, which is selected for composition by a user, may be downloaded in one batch from the database 200 to the user computer 400 or 402. In this case, blocked musical elements stored in the hard disk of the user's computer 400 or 402 may be used without requiring the user computer 400 or 402 to connect to the server 100 every time a drag-and-drop action is performed.

Then, the user may replay the music consisting of the blocked musical elements by operating on the control portion 208, which includes typical replay function buttons, such as a forward button, a rewind button, a pause button and the like. The control portion 208 may further include operating buttons related to volume control and input/output of a music file. According to an embodiment of the present invention, the composed music may be stored in a format of a music file, such as MP3.

The user may then continue to select an instrument for track 2 and subsequent tracks on the track setting portion 204, select desired blocked musical elements having sounds of the selected instrument, and arrange them on the music block arranging portion 206 to complete the composition. Since blocked musical elements in accordance with the present invention do not simply have information related to tones and beats of a sound, but also include information for a unique tone color of an instrument, the user may be able to compose music of much higher quality. Meanwhile, by operating on the user interface 210, the user may be able to copy or move the blocked musical elements previously arranged on the music block arranging portion 206.

Therefore, the user can easily compose even an ensemble by sequentially performing compositions for respective tracks, and complete composition of the ensemble of much higher quality by individually adjusting the volumes of the respective tracks.

In a preferred embodiment of the present invention, a chord recommendation function can be implemented based on chord information of blocked musical elements arranged for an earlier completed track. It can be seen from FIG. 2 that instruments capable of expressing a different kind of melody are selected for track 2 or other lower tracks. While an ensemble involving several instruments (particularly, instruments capable of expressing a melody) is being composed, the ensemble must not have a discord. However, when an amateur composer composes an ensemble depending only on his or her feeling by arranging blocked musical elements on the music block arranging portion 206, a discord is highly expectable. Therefore, according to a preferred embodiment of the present invention, blocked musical elements may be recommended based on chord information. For example, a chord for each music block may be set on an upper track (e.g., track 2 for a play by a base guitar). Then, on lower tracks, a blocked musical element having a chord matching with one on the upper track may be preferentially recommended, so that even a complicated ensemble can be composed without causing any disharmony. This kind of recommendation may be enabled by highlighting some blocked musical elements on the music block group display portion 202. Alternatively, this kind of recommendation may be enabled by restricting blocked musical elements causing disharmony from being arranged on the music block arranging portion 206. According to an embodiment of the present invention, a metadatum regarding chord information may be included in blocked musical elements, which are stored in the database 200, so that the above recommendation function may be more easily implemented.

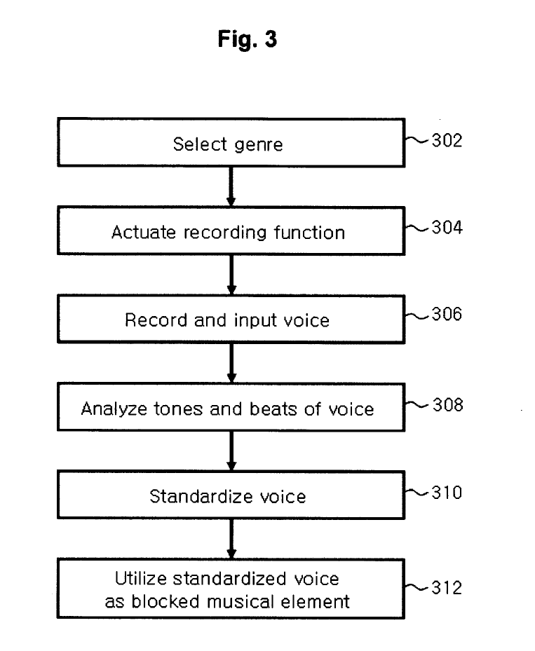

According to another preferred embodiment of the present invention, a user's recorded voice may be used as a source of a blocked musical element, as described with reference to FIG. 3.

FIG. 3 is a flowchart illustrating the usage of a voice recording function provided by a composition system in accordance with an embodiment of the present invention. As shown in FIG. 3, a user selects a genre of music he or she wants to compose (step 302). On the user interface 210, the user can actuate the voice recording function (step 304). After actuating the voice recording function, the user records and inputs his or her voice by using a well-known voice input device (e.g., a microphone) equipped with the user computer 400 or 402 (step 306). The server 100 then receives the recorded voice signal from the user computer 400 or 402 and analyzes tones and beats of the inputted voice (step 308). Alternatively, receiving a recorded voice signal and/or analyzing tones and beats may be done by the composition software package on the user computer 400 or 402, if necessary. As explained above, the server 100 includes the program module for standardizing a voice. This program module first analyzes the tones of the inputted voice of the user and reflects the tones onto a standard musical scale to extract standardized musical tones. Then, it standardizes the length of each sound (step 310). This standardization may be performed by the composition program package on the user computer 400 or 402.

Through the voice standardization, irregular tones of a user's voice can be adjusted to regular ones and the length of each sound can be adjusted to a standard one. Such voice standardization involves a quantization process of sampling a user's voice, which is a continuous analog signal, at certain intervals and selecting a standard tone value closest to the tone value of the sampled voice, and a process of adjusting the length of each sound to correspond to a standard one.

Thereafter, the standardized user voice may be used for composition as a blocked musical element stored in a predetermined storage device of the server 100 or the user computers 400 and 402, just like an existing blocked musical element (step 312).

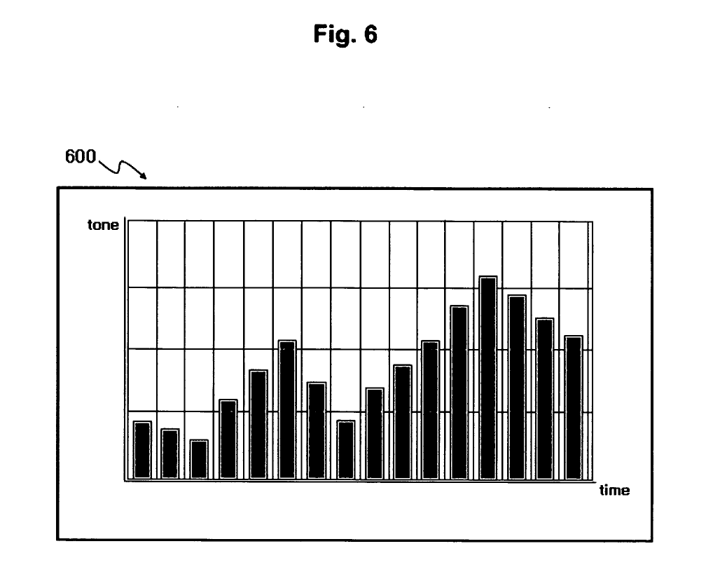

According to another embodiment of the present invention, a blocked musical element may be created by using a melody shape drawn by a user on any user interface, instead of actuating the voice recording function. This will be described with reference to FIG. 6.

FIG. 6 illustrates an example of another user interface of a composition system in accordance with the present invention. The user interface 600 shown in FIG. 6 allows a user to directly draw a melody shape.

According to this embodiment, the user can adjust the height of a mouse pointer while moving the mouse pointer from the left to the right on the user interface 600. Thereafter, continual bars having heights varying with the movement of the mouse pointer may be displayed on the user interface 600, as shown in FIG. 6. Preferably, one cell on the horizontal axis of the bar graph may correspond to the 1/16 beat, and one cell on the vertical axis may correspond to one octave.

However, in case the tone of a sound is decided exactly based on the height indicated by the bar graph, the resultant sounds would be out of regular tones, and thus, sound awkward. According to the above-mentioned embodiment of the present invention, on the other hand, the length of sounds may have been already standardized upon creating the bar graph as shown in FIG. 6. Therefore, the server 100 or the composition software package on the user computer 400 or 402 in accordance with the present invention standardizes the tones of sounds based on the shape of the inputted melody. Consequently, according to the present invention, a user can create a new blocked musical element by drawing a melody shape he or she desires to express in music and use it immediately or later.

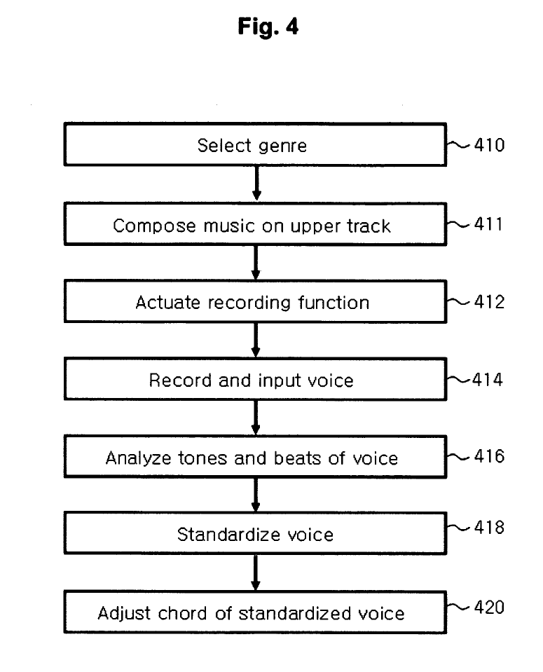

According to another embodiment of the present invention, in case there exists a track of a composed melody and a user's recorded voice is standardized and obtained as a blocked musical element, the chord of the user's recorded voice may be further adjusted based upon chord information of the music on the existing composed track. This will be descried with reference to FIG. 4.

FIG. 4 is a flowchart illustrating the usage of a voice recording function provided by a composition system in accordance with another embodiment of the present invention.

Referring to FIG. 4, a user selects a genre (step 410), activates a user interface 210, and composes music for one track by using a predetermined instrument (step 411). The composed track has one or more sounds that accord to the law of harmony. Thereafter, the user completes an upper track with one melody, and then selects a voice recording function for a lower track (step 412). Subsequent steps, such as the steps of recording/inputting voice (step 414), analyzing the tones and beats of the inputted voice (step 416), and standardizing the voice based on the analysis of the tones and beats (step 418) are the same as the above-described steps 306 to 310. Thereafter, the standardized user voice may be adjusted to chord with the sounds on the upper track, for which composition was earlier completed (step 420).

Then, the standardized and chord-adjusted user voice may be used as a blocked musical element.

Hereinafter, step 420 will be described in a more detailed manner. Specifically, the user voice to be chord-adjusted in step 420 has been already standardized in terms of the tones and beats of the sound itself. However, when the chord of the melody from the standardized user voice does not match that on the earlier composed track, a discord would be caused. To prevent such a discord, the present invention may employ adjusting the chord of the melody from the user voice as much as needed. For example, if the chord on the upper track is a C code, at least a part of the tones of the user voice may be adjusted to any of do, mi and sol. Further, if there already exists a do, mi or sol sound, such sound may be emphasized. In other words, such sound may be extended or focused. For example, a half-time tone of a sound, such as do and mi, in the user voice may be extended to be a one-and-half tone.

According to another embodiment of the present invention, a sound generated by a virtual instrument based on the standardized and chord-adjusted voice, instead of the standardized and chord-adjusted voice itself, may be used and contained in a blocked musical element. Replacing a standardized and chord-adjusted user voice with a sound from a virtual instrument would be more useful in case the standardized and chord-adjusted user voice becomes considerably different from the original input voice during the process of standardization and chord adjustment. In this embodiment, the virtual instrument may be a well-known program module capable of receiving a predetermined music sheet and playing the music sheet to express sounds with a unique tone color of an actual instrument.

According to an embodiment of the present invention, the chord adjustment scheme described above may be applied to adjusting the chord of sounds based on a melody shape.

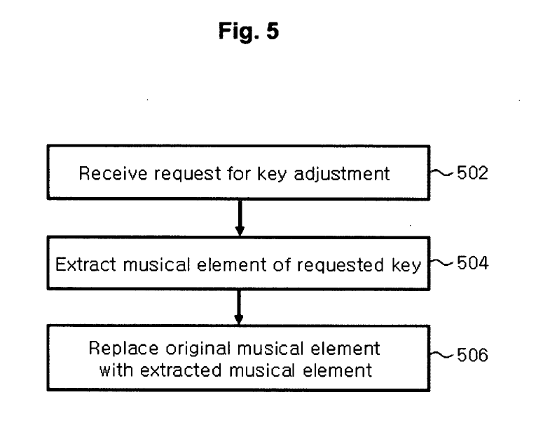

In another preferred embodiment of the present invention, the quality of a music sound may be maintained excellent even after the key of the music sound has been changed. This embodiment will be described with reference to FIG. 5.

Conventionally, pitch control has been essential to change the key of a musical element. That is, in order to change the key of a selected musical element, analyzing the pitch of the sound in the musical element in a computational manner and adding or subtracting a desired pitch increment or decrement by half or one tone to or from the pitch of each musical element has been necessary. Accordingly, performing such pitch control has been a cause of a high computational load during the key adjustment and degradation of the sound quality of the musical element.

To solve this problem, in a preferred embodiment of the present invention, several blocked musical elements having different keys for one melody are provided on the database 200.

As shown in FIG. 5, which is a flowchart illustrating the usage of a key adjustment function provided by a composition system in accordance with an embodiment of the present invention, the user computer 400 or 402 sends the server 100 a key adjustment request message (step 502), and the server 100 extracts from the database 200 a blocked musical element having the requested key and the same melody with a blocked musical element arranged previously on the music block arranging portion 206 (step 504). The server 100 then replaces the blocked musical element arranged previously on the music block arranging portion 206 with the extracted blocked musical element (step 506). In another embodiment of the present invention, key adjustment as above may be performed by the composition software package on the user computer 400 or 402, which refers to a local database downloaded thereto.

### EFFECTS FROM PRACTICING THE PRESENT INVENTION

Therefore, according to the present invention, ordinary persons other than professional composers can compose music more easily. In concrete, the present invention has the following advantages:

According to the present invention, a large amount of music sources can be provided to a user in a database including blocked musical elements, which intervenes in communication between a server and a client computer.

According to the present invention, blocked musical elements can be initiated based on a user's voice or a melody shape drawn by the user. Additionally, providing such blocked musical elements would be helpful to drawing users' attention.

A user can more easily compose an ensemble by using the chord recommendation function in accordance with the present invention.

According to the present invention, a key of a music block may be adjusted without causing any unnecessary computational load. Further, after iterating several key adjustments, the sound quality of the music block will not deteriorate.

Only with a microphone that is usable to produce a new blocked musical element in accordance with the present invention, a user can compose music.

While the present invention has been shown and described with respect to the preferred embodiments, it will be understood by those skilled in the art that various changes and modifications may be made without departing from the spirit and the scope of the present invention as defined in the following claims.

What is claimed is:

1. A composition system comprising,
at least one database including a plurality of blocked musical elements, and
a composition server, the composition server including,
a receiving portion for receiving a signal associated with a melody shape inputted from a terminal,
a sound standardizing portion for analyzing tones and beats of a sound depicted by the melody shape and standardizing the sound, and
a storage device for storing the sound standardized by the sound standardizing portion,
wherein the standardized sound is capable of being transmitted, as at least one blocked musical element, to the terminal.

2. A composition system comprising,
at least one database including a plurality of blocked musical elements, and
a composition server, the composition server including,
a receiving portion for receiving chord information of music that is being composed in a terminal, and
a musical element recommendation portion for recommending at least one blocked musical element from the at least one database based on the received chord information,
wherein the at least one recommended blocked musical element is capable of being transmitted to the terminal.

3. A composition system comprising,
at least one database including a plurality of blocked musical elements, and
a composition server, the composition server including,
a receiving portion for receiving key information of music that is being composed in a terminal, and
a musical element extraction portion for extracting at least one blocked musical element from the at least one database based on the key information,
wherein the at least one extracted blocked musical element is capable of being transmitted to the terminal.

4. A composition system comprising,
at least one database including a plurality of blocked musical elements, and
a composition server, the composition server including,
a first receiving portion for receiving a signal associated with a melody shape inputted from a terminal,
a second receiving portion for receiving chord information of music that is being composed in the terminal,
a sound standardizing portion for analyzing tones and beats of a sound depicted by the melody shape and standardizing the sound,
a chord adjusting portion for adjusting the standardized sound based on the received chord information,
a storage device for storing the standardized and chord-adjusted sound, and
a virtual instrument for playing the standardized and chord-adjusted sound,
wherein the standardized and chord-adjusted sound is capable of being transmitted, as at least one blocked musical element, to the terminal.

5. A method for implementation in a composition system comprising at least one database including a plurality of blocked musical elements and a composition server, the method comprising the steps of:
receiving a signal associated with a melody shape inputted from a terminal,
analyzing tones and beats of a sound depicted by the melody shape and standardizing the sound, and
storing the standardized sound,
wherein the standardized sound is capable of being transmitted, as at least one blocked musical element, to the terminal.

6. A method for implementation in a composition system comprising at least one database including a plurality of blocked musical elements and a composition server, the method comprising the steps of:
receiving chord information of music that is being composed in a terminal, and
recommending at least one blocked musical element from the at least one database based on the received chord information,
wherein the at least one recommended blocked musical element is capable of being transmitted to the terminal.

7. A method for implementation in a composition system comprising at least one database including a plurality of blocked musical elements and a composition server, the method comprising the steps of:
receiving key information of music that is being composed in a terminal, and
extracting at least one blocked musical element from the at least one database based on the key information,
wherein the at least one extracted blocked musical element is capable of being transmitted to the terminal.

8. A method for implementation in a composition system comprising at least one database including a plurality of blocked musical elements and a composition server, the method comprising the steps of:
receiving a signal associated with a melody shape inputted from a terminal and chord information of music that is being composed in the terminal,
analyzing tones and beats of a sound depicted by the melody shape and standardizing the sound,
adjusting the standardized sound based on the received chord information, and
playing the standardized and chord-adjusted sound with a virtual instrument,
wherein the standardized and chord-adjusted sound is capable of being transmitted, as at least one blocked musical element, to the terminal.

9. A method for implementation in a terminal comprising at least one database including a plurality of blocked musical elements, the method comprising the steps of:
receiving and storing a signal associated with a user's voice,
analyzing tones and beats of the voice and standardizing the voice, and
storing the standardized voice,
wherein the standardized voice is provided as at least one blocked musical element.

10. A method for implementation in a terminal comprising at least one database including a plurality of blocked musical elements, the method comprising the steps of:
receiving and storing a signal associated with a melody shape inputted from the terminal,
analyzing tones and beats of a sound depicted by the melody shape and standardizing the sound, and
storing the standardized sound,
wherein the standardized sound is provided as at least one blocked musical element.

11. A method for implementation in a terminal comprising at least one database including a plurality of blocked musical elements, the method comprising the steps of:
obtaining chord information of music that is being composed in the terminal, and
recommending at least one out of the plurality of blocked musical elements based on the obtained chord information.

12. A method for implementation in a terminal comprising at least one database including a plurality of blocked musical elements, the method comprising the steps of:
obtaining key information of music that is being composed in the terminal, and
extracting from the at least one database at least one out of the plurality of blocked musical elements based on the obtained key information.

13. A method for implementation in a terminal comprising at least one database including a plurality of blocked musical elements, the method comprising the steps of:
receiving a signal associated with a user's voice and chord information of music that is being composed in the terminal,
analyzing tones and beats of the voice and standardizing the voice,
adjusting the standardized voice based on the received chord information, and
storing the standardized and chord-adjusted voice,
wherein the standardized and chord-adjusted voice is provided as at least one blocked musical element.

14. A method for implementation in a terminal comprising at least one database including a plurality of blocked musical elements, the method comprising the steps of:
receiving a signal associated with a user's voice and chord information of music that is being composed in the terminal,
analyzing tones and beats of the voice and standardizing the voice,
adjusting the standardized voice based on the received chord information, and
playing the standardized and chord-adjusted voice with a virtual instrument,
wherein the sound from the virtual instrument is provided as at least one blocked musical element.

15. A method for implementation in a terminal comprising at least one database including a plurality of blocked musical elements, the method comprising the steps of:
receiving a signal associated with a melody shape inputted from the terminal and chord information of music that is being composed in the terminal,
analyzing tones and beats of a sound depicted by the melody shape and standardizing the sound,
adjusting the standardized sound based on the received chord information, and
playing the standardized and chord-adjusted sound with a virtual instrument,
wherein the sound from the virtual instrument is provided as at least one blocked musical element.

16. A computer recording medium for recording a computer program for implementing the method in accordance with claim 9.
